(19) United States
(12) Patent Application Publication
(10) Pub. No.: US 2016/0230124 A1
(43) Pub. Date: Aug. 11, 2016

(54) LIQUID LAUNDRY CLEANING COMPOSITION

(71) Applicant: The Procter & Gamble Company, Cincinnati, OH (US)

(72) Inventors: Neil Joseph LANT, Newcastle upon Tyne (GB); Steven George PATTERSON, Tyne & Wear (GB); Nigel Patrick SOMERVILLE ROBERTS, Newcastle upon Tyne (GB); Victor Stuart REID, Newcastle upon Tyne (GB); Alan Thomas BROOKER, Newcastle upon Tyne (GB)

(21) Appl. No.: 15/011,694

(22) Filed: Feb. 1, 2016

Related U.S. Application Data
(60) Provisional application No. 62/114,121, filed on Feb. 10, 2015.

(51) Int. Cl. C11D 3/22; C11D 17/04

(52) U.S. Cl. CPC C11D 3/222; C11D 17/043; C11D 3/225

(57) ABSTRACT

A cleaning composition being a liquid laundry treatment composition or component thereof, comprising a substituted polysaccharide particle having a mean particle size as expressed by the area-equivalent diameter from about 1 to 100 μm according to ISO 9276-6 and a laundry adjunct ingredient.

### FIELD OF THE INVENTION

The present invention relates to liquid cleaning compositions comprising substituted polysaccharide particles having a mean particle size as expressed by the area-equivalent diameter from 1 to 100 μm. The liquid cleaning compositions of the present invention are in particular suitable for use in laundry detergent compositions or other fabric-treatment compositions.

### BACKGROUND OF THE INVENTION

When articles such as clothes and other textiles are washed, cleaning performances may be affected by the redeposition of the soil onto the fabrics. The redeposition of the soil may manifest itself as a general greying of the textiles. Already in the 1930's it was discovered that a substituted polysaccharide, Carboxymethyl Cellulose (CMC), was particularly suitable as an antiredeposition agent and could be used in the washing water to alleviate this redeposition problem.

Although there are nowadays many types of commercial substituted polysaccharides, the substituted polysaccharide used in the laundry compositions have remained substantially the same for the past decades and have been used primarily in dry or granule form. Indeed, prior attempts to use substituted polysaccharides in liquid cleaning compositions have traditionally resulted in the polysaccharide precipitating out of solution and causing a decreased performance or being extremely difficult to manufacture and process.

It has now surprisingly been found that a specific class of substituted polysaccharide particles having mean particle size as expressed by the area-equivalent diameter from 1 to 100 μm unexpectedly provide optimal solubility and processing capabilities and therefore perform better when compared with the substituted polysaccharides traditionally present in the commercial detergent compositions.

### SUMMARY OF THE INVENTION

The invention concerns a composition being a liquid laundry treatment composition or component thereof, comprising:

a substituted polysaccharide particle having a mean particle size as expressed by the area-equivalent diameter from about 1 to 100 μm according to ISO 9276-6 and

a laundry adjunct ingredient.

### DETAILED DESCRIPTION OF THE INVENTION

### Substituted Polysaccharide

As used herein, the term “polysaccharides” includes natural polysaccharides, synthetic polysaccharides, polysaccharide derivatives and modified polysaccharides. Natural polysaccharides can be extracted from plants, produced by microorganisms, such as bacteria, fungi, prokaryotes, eukaryotes, extracted from animal and/or humans. For example, xanthan gum can be produced by Xanthomonas campestris, gellan gum by Sphingomonas paucimobilis, xyloglucan can be extracted from tamarind seed.

The laundry treatment composition of the invention comprises a substituted polysaccharide. The substituted polysaccharide comprises a polysaccharide backbone, linear or branched, containing identical or different sugar units.

According to one alternative of the invention, the degree of substitution, DS, of the substituted polysaccharide is of from 0.01 to 0.99. The sum of the degree of substitution and the degree of blockiness, DS+DB, of the substituted polysaccharide may be of at least 1. The DB+2DS-DS² of the substituted polysaccharide may be of at least 1.20.

The substituted polysaccharide may be substituted with identical or different substituents.

The composition of the invention may comprise at least 0.001%, or even at least 0.01% by weight of substituted polysaccharide particles. In particular the composition may comprise from 0.03% to 20%, especially from 0.1 to 10, or even from 0.3 to 3, for example from 1 to 1.5% by weight of substituted polysaccharide particles.

The substituted polysaccharide comprises unsubstituted sugar units. Unsubstituted sugar units are sugar units having all their hydroxyl groups remaining unsubstituted. In the substituted polysaccharide, the weight ratio of unsubstituted sugar units to the total number of sugar units may be comprised between 0.01 to 0.99.

The substituted polysaccharide comprises substituted sugar units. Substituted sugar units are sugar units having at least one of their hydroxyl groups being substituted. In the substituted polysaccharide, the weight ratio of substituted sugar units to the total number of sugar units may be comprised between 0.01 to 0.99.

### Polysaccharide Backbone

The polysaccharide backbone consists essentially of sugar units. The polysaccharide backbone can be linear (like in cellulose), it can have an alternating repeat (like in carrageenan), it can have an interrupted repeat (like in pectin), it can be a block copolymer (like in alginate), it can be branched (like in dextran), or it can have a complex repeat (like in xanthan). Descriptions of the polysaccharides are given in “An introduction to Polysaccharide Biotechnology”, by M. Tombs and S. E. Harding, T.J. Press 1998.

The polysaccharide backbone can be linear, or branched in a variety of ways such as α- or β- and 1-2, 1-3, 1-4, 1-6 or 2-3 linkages and mixtures thereof. Many naturally occurring polysaccharides have at least some degree of branching, or at any rate, at least some saccharide rings are in the form of pendant side groups on a main polysaccharide backbone.

The polysaccharide backbone may be substantially linear. By substantially linear it is to be understood that at least 97%, for example at least 99% (by weight), or all the sugar units of the polymer are in the main chain of the polysaccharide backbone.

The polysaccharide backbone preferably include, but is not limited to, one or more of the following sugar units: glucose, fructose, galactose, xylose, mannose, arabinose, rhamnose, fucose, ribose, lyxose, allose, altrose, gulose, idose, talose, glucuronic acid, and mixtures thereof.

Typically, the polysaccharide backbone is substantially constituted of sugar units selected from: glucose, fructose, galactose, xylose, mannose, arabinose, rhamnose, fucose, ribose, lyxose, allose, altrose, gulose, idose, talose, glucuronic acid, and mixtures thereof. Typically, at least one of the sugar unit, or even substantially all of them, is/are selected from glucose, xylose, galactose, arabinose, glucuronic acid, and/or mannose.

Typically, the polymeric backbone is selected from celluloses, xyloglucans, mannans, xylans, starches, and mixtures thereof.

### Substituent

The substituted polysaccharide comprises at least one sugar unit of its backbone which is substituted. Suitable substituents may be selected from the group consisting of branched, linear or cyclic, substituted or not substituted, saturated or unsaturated alkyl, amine (primary, secondary, tertiary), ammonium salt, amide, urethane, alcohol, carboxylic acid, tosylate, sulfonate, sulfate, nitrate, phosphate, silicone, and mixtures thereof.

The substitution may take place on any hydroxyl group of the sugar unit. For example, in the case of a glucose unit linked by β-1,4 linkage to other glucose units, the substitution can take place in position 2, 3 and/or 6 of the glucose unit.

The hydroxyl group —OH of the sugar may be substituted with a —O—R or —O—C(═O)—R group.

R may be an anionic, a cationic or a non-ionic group. R may be selected from the group consisting of: R₁, N(R₂)(R₃), silicone moiety, SO₃⁻, PO₃⁻, with R₂ and R₃ being independently of each other an hydrogen atom or a C₁₋₆ alkyl and R₁ being a linear or branched, typically linear, saturated or unsaturated, typically saturated, substituted or unsubstituted, typically substituted, cyclic or acyclic, typically acyclic, aliphatic or aromatic, typically aliphatic, C₁-C₃₀₀, typically C₁-C₃₀, C₁-C₁₂, or C₁-C₆ hydrocarbon radical which hydrocarbon backbone may be interrupted by a heteroatom chosen form O, S, N and P. R₁ may be substituted by one or more radical selected from amino (primary, secondary, or tertiary), amido, —OH, —CO—OR₄, —SO₃⁻, R₄, —CN, and —CO—R₄, where R₄ represents a hydrogen atom or an alkali metal, preferably a sodium or potassium, ion.

R may be one following anionic groups, in its acid or salt form, preferably sodium (given here) or potassium salt form:

### -T-CO₂Na

### -T-SO₃Na

### —PO₃Na

### —SO₃Na

Wherein T is a C₁₋₆ alkyl, more preferably C₁₋₄ alkyl.

The R substituent may be the following cationic group:

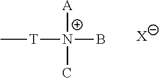

Wherein T is a C₁₋₆ alkyl, or CH₂CH(OH)CH₂, each A, B, and C is C₁₋₆ alkyl or hydroxy-C₁₋₆ alkyl, X is a counterion such as halide or tosylate.

R may be one following non-ionic groups:

### -A

### -T-OH

### -T-CN

### —C(═O)A

### —C(═O)NH₂

### —C(═O)NHA

### —C(═O)N(A)B

### —C(═O)OA

—(CH₂CH₂CH₂O)ₙZ
—(CH₂CH₂O)ₙZ
—(CH₂CH(CH3)O)ₙZ
—(CH₂O)ₙZ

Wherein: A and B are C₁₋₃₀ alkyl; T is C₁₋₆ alkyl; n=1 to 100; Z is H or C₁₋₆ alkyl.

R may be a hydroxyalkyl, carboxyalkyl, or sulfoalkyl group or a salt thereof. R may represent a hydroxy C₁₋₄ alkyl, such as a 5-hydroxymethyl group, a carboxy C₁₋₆ alkyl, such as a carboxy C₁₋₄ alkyl group, or a sulfo-C₂₋₄ alkyl, such as a sulfoethyl group, a C₁-C₃₀ alkanoyl or a salt (for example a sodium salt) thereof.

In exemplary alternatives, —O—R represents a group selected from —O—CH₂OH, —O—CH₂CH₂SO₃H, —O—CH₂—CO₂H, —O—CO—CH₂CH₂CO₂H, and salt (for example a sodium salt) thereof. Preferably, the substituent is a carboxymethyl group.

The substitutent may be a benefit group, suitable benefit groups include perfumes, perfume particles, enzymes, fluorescent brighteners, oil repellent agents, water repellent agents, soil release agents, soil repellent agents, dyes including fabric renewing dyes, hueing dyes, dye intermediates, dye fixatives, lubricants, fabric softeners, photofading inhibitors, antiwrinkle/ironing agents, shape retention agents, UV absorbers, sunscreens, antioxidants, crease resistant agents, antimicrobial agents, skin benefit agents, anti-fungal agents, insect repellents, photobleaches, photoinitiators, sensates, enzyme inhibitors, bleach catalysts, odor neutralizing agents, pheromones, and mixtures thereof.

### Degree of Substitution (DS).

The substituted polysaccharide of the invention has a DS of from 0.01 to 0.99.

As those of skill in the art of cellulosic polymers chemistry, recognize, the term “degree of substitution” (or DS) refers to average degree of substitution of the functional groups on the polysaccharide units of the polysaccharide backbone. The maximum DS is the average number of free hydroxyl groups available per sugar monomer in the polymer. Cellulose and amylose, therefore have a maximum DS of three. Homoxylan has a maximum DS of 2. The maximum DS of more complex polysaccharides depends on the level of branching and natural substituents present on the backbone. However, the maximum DS and actual DS of a given substituent can be calculated by those skilled in the art using a variety of analytical techniques such as NMR spectroscopy or HPLC. For example, techniques for evaluating the DS of xylan derivatives are given in K. Petzold et al, Carbohydrate Polymers, 2006, v64, pp 292-298. Techniques for evaluating the DS of starch derivatives are given in M. Elomaa et al, Carbohydrate Polymers, 2004, v57, pp 261-267. Techniques for evaluating the DS of cellulose derivatives are given in V. Stiggsson et al, Cellulose, 2006, v13, pp 705-712. Techniques for evaluating the DS of xyloglucan derivatives are cited in P. Goyal et al, Carbohydrate Polymers, 2007, v69, pp 251-255.

DS values do not generally relate to the uniformity of substitution of chemical groups along the polysaccharide backbone and are not related to the molecular weight of the polysaccharide backbone. The degree of substitution of the substituted polysaccharide may be of at least 0.02, or 0.05, in particular of at least 0.10, or 0.20, or even 0.30. Typically, the degree of substitution of the polysaccharide backbone is from 0.50 to 0.95, in particular from 0.55 to 0.90, or from 0.60 to 0.85, or even from 0.70 to 0.80.

### Degree of Blockiness (DB)

In one alternative, the substituted polysaccharide of the invention has a DB. It will be understood that the description below regarding DB is only applicable to those alternatives of the invention having a DB. In such emdboidments, the substituted polysaccharide of the invention has a DB such as either DB+DS is at least of 1 or DB+2DS-DS² is of at least 1.10.

As those of skill in the art of cellulosic polymers chemistry recognise, the term “degree of blockiness” (DB) refers to the extent to which substituted (or unsubstituted) sugar units are clustered on the polysaccharide backbone. Substituted polysaccharides having a lower DB may be characterized as having a more even distribution of the unsubstituted sugar units along the polysaccharide backbone. Substituted polysaccharides having a higher DB may be characterized as having more clustering of the unsubstituted sugar units along the polysaccharide backbone.

More specifically, in a substituted polysaccharide comprising substituted and unsubstituted sugar units, the DB of the substituted polysaccharide is equal to B/(A+B), with A referring to the number of unsubstituted sugar units directly linked to at least one substituted sugar units, and B refers the number of unsubstituted sugar units not directly linked to a substituted sugar unit (i.e. only directly linked to unsubstituted sugar units).

Typically, the substituted polysaccharide has a DB of at least 0.35, or even from 0.40 to 0.90, from 0.45 to 0.80, or even from 0.50 to 0.70.

The substituted polysaccharide may have a DB+DS of at least 1. Typically the substituted polysaccharide has a DB+DS of from 1.05 to 2.00, or from 1.10 to 1.80, or from 1.15 to 1.60, or from 1.20 to 1.50, or even from 1.25 to 1.40.

The substituted polysaccharide having a DS comprised between 0.01 and 0.20 or between 0.80 to 0.99 may have a DB+DS of at least 1, typically of from 1.05 to 2.00, or from 1.10 to 1.80, or from 1.15 to 1.60, or from 1.20 to 1.50, or even from 1.25 to 1.40.

The substituted polysaccharide having a DS comprised between 0.20 and 0.80 may have a DB+DS of at least 0.85, Typically of from 0.90 to 1.80, or from 1.00 to 1.60, or from 1.10 to 1.50, or from 1.20 to 1.40.

The substituted polysaccharide may have a DB+2DS-DS² of at least 1.20. Typically the substituted polysaccharide has a DB+2DS-DS² of from 1.22 to 2.00, or from 1.24 to 1.90, or from 1.27 to 1.80, or from 1.30 to 1.70, or even from 1.35 to 1.60.

The substituted polysaccharide, having a DS comprised between 0.01 and 0.20, may have a DB+2DS-DS² of from 1.02 or 1.05 to 1.20.

The substituted polysaccharide, having a DS comprised between 0.20 and 0.40, may have a DB+2DS-DS² of from 1.05 or 1.10 to 1.40.

The substituted polysaccharide, having a DS comprised between 0.40 and 1.00 or between 0.60 and 1.00 or between 0.80 and 1.00, may have a DB+2DS-DS² of from 1.10 to 2.00, or from 1.20 to 1.90, or from 1.25 to 1.80, or from 1.20 to 1.70, or even from 1.35 to 1.60.

The methods to measure the DB may vary as a function of the substituent. The skilled person knows or may determine how to measure the degree of substitution of a given substituted polysaccharide.

The blockiness of the polysaccharide derivatives can be determined by comparing the amount of unsubstituted sugar units produced by acid treatment with the amount of unsubstituted sugar units produced by enzymatic treatment. At a given DS, the relative amount of unsubstituted sugar monomers produced by enzymatic treatment increases with increasing blockiness, as described in V. Stiggsson et al, Cellulose, 2006, v13, pp 705-712. The degree of blockiness is calculated by dividing the quantity of enzyme-liberated sugar units by the quantity of acid-liberated sugar units.

Examples of enzyme classes usable for the enzymatic digestion are listed in the table below.

| Polysaccharide backbone | Enzyme classes | E.C. Number |
|---|---|---|
| Cellulose | endo-β-1,4-glucanase | 3.2.1.4 |
| Homoxylan | endo-1,4-β-xylanase | 3.2.1.8 |
| Amylose | α-amylase | 3.2.1.1 |
| Amylopectin | α-amylase | 3.2.1.1 |
| | pullulanase | 3.2.1.41 |
| (Glucurono)arabinoxylan | glucuronoarabinoxylan endo- | 3.2.1.136 |
| | 1,4-β-xylanase | |
| | endo-1,4-β-xylanase | 3.2.1.8 |
| Galactomannan | mannan endo-1,4-β- | 3.2.1.78 |
| | mannosidase | |
| | α-galactosidase | 3.2.1.22 |
| Glucomannan | mannan endo-1,4-β- | 3.2.1.78 |
| | mannosidase | |
| Arabinoxylan | endo-1,4-β-xylanase | 3.2.1.8 |
| | α-arabinofuranosidase | 3.2.1.55 |
| | xylan 1,4-β-xylosidase | 3.2.1.37 |
| | feruloyl esterase | 3.1.1.73 |
| | endo-1,5-α-arabinanase | 3.2.1.99 |
| (Arabino)glucuronoxylan | endo-1,4-β-xylanase | 3.2.1.8 |
| | xylan 1,4-β-xylosidase | 3.2.1.37 |
| | α-arabinosidase | 3.2.1.55 |
| | α-glucuronidase | 3.2.1.139 |
| Xyloglucan | endo-β-1,4-glucanase | 3.2.1.4 |
| | xyloglucan-specific endo-β- | 3.2.1.151 |
| | 1,4-glucanase | |
| | α-xylosidase | 3.2.1.— |

### Mean Particle Size

The liquid cleaning compositions herein comprise substituted polysaccharide particles formed by shearing and/or graining. The substituted polysaccharide particles have a mean ECD from 1 μm to 100 μm, preferably from 30 μm to 70 μm and most preferably from 40 to 50 μm.

The substituted polysaccharide particle size is critical to achieve an optimal suspension in the cleaning composition. On the one hand use of excessively small particle sizes e.g.: below 1 micrometers provide good solubility in solution, but are very difficult to manufacture and process. On the other hand, use of excessively high particle size, e.g.: above 100 micrometers provide a solution where the particle precipitate out, but are much easier to handle and process. Therefore, the applicants define herein an optimal particle size range that delivers both optimal solubility and processing capabilities.

The substituted polysaccharide particles have size defined by their area-equivalent diameter (ISO 9276-6:2008(E) section 7) also called Equivalent Circle Diameter ECD (ASTM F1877-05 Section 11.3.2). Mean ECD of particle population is calculated as the average of respective ECD of each particles of a particle population of at least 10 000 particles, preferably above 50 000 particles, more preferably above 100 000 particles. Mean data are extracted from volume-based vs. number-based measurements.

In one alternative, the mean ECD of the substituted polysaccharide particles may be generated by dispersing and suspending the substituted polysaccharide particles in an inert diluent and measuring in a shape analysis instrument such as the Malvern Morphologi G3. For the avoidance of doubt, one skill in the art would recognize that the inert diluent is chosen to avoid causing the substituted polysaccharide particles to swell.

### Viscosity of the Substituted Polysaccharide.

The substituted polysaccharide has typically a viscosity at 25° C. when dissolved at 2% by weight in water of at least 100 mPa·s for example a viscosity of from 250 to 5000, or from 500 to 4000, from 1000 to 3000 or from 1500 to 2000 mPa·s. The viscosity of the polysaccharide may be measured according to the following test method.

### Test Method 3: Evaluation of Substituted Polysaccharide Viscosity

A solution 2% by weight of the polysaccharide is prepared by dissolving the polysaccharide in water. The viscosity of the solution is determined using a Haake VT500 viscometer at a shear rate of 5 s⁻¹, at 25° C. Each measurement is done for 1 minute with 20 measuring points collected and averaged.

### Molecular Weight of the Substituted Polysaccharide.

Typically, the polysaccharides of the present invention have a molecular weight in the range of from 10 000 to 10 000 000, for example from 20 000 to 1 000 000, typically from 50 000 to 500 000, or even from 60 000 to 150 000 g/mol.

### Degree of Polymerisation (DP) of the Substituted Polysaccharide.

The substituted polysaccharide may have a total number of sugar units from 10 to 7000, or of at least 20. Suitable substituted polysaccharides that are useful in the present invention include polysaccharides with a degree of polymerization (DP) over 40, preferably from about 50 to about 100,000, more preferably from about 500 to about 50,000.

The total number of sugar units of the substituted polysaccharide is for example from 10 to 10 000, or 20 to 7500, for example 50 to 5000 and typically 100 to 3000, or from 150 to 2000.

### Synthesis

The substituted polysaccharides used in the present invention may be synthesised by a variety of routes which are well known to those skilled in the art of polymer chemistry. For instance, carboxyalkyl ether-linked polysaccharides can be made by reacting a polysaccharide with a suitable haloalkanoic acid, carboxyalkyl ester-linked polysaccharides can be made by reacting a polysaccharide with a suitable anhydride, such as succinic anhydride, and sulfoalkyl ether-linked polysaccharides can be made by reacting a polysaccharide with a suitable alkenyl sulfonic acid.

The skilled person may obtain substituted polysaccharide with a higher degree of blockiness for example by choosing the solvent of the reaction, the rate of addition of the reactants, and the alkalinity of the medium during the substituted polysaccharide synthesis. The synthetic process can be optimised to control the DB, as discussed in V. Stigsson et al., Polysaccharide, 2006, 13, pp 705-′712; N. Olaru et al, Macromolecular Chemistry & Physics, 2001, 202, pp 207-211; J. Koetz et al, Papier (Heidelburg), 1998, 52, pp 704-′712; G. Mann et al, Polymer, 1998, 39, pp 3155-3165. Methods for producing carboxymethyl polysaccharide and hydroxyethyl polysaccharide having blocky characteristics are also disclosed in WO 2004/048418 (Hercules) and WO 06/088953 (Hercules).

### Process for Manufacturing the Substituted Polysaccharides

The substituted polysaccharides used in the present invention may be manufactured by a variety of routes which are well known to those skilled in the art. For instance, the substituted polysaccharides may be milled and ground by Fine Cutting Mills—for example the CS-Z range from Hosakawa Micron. In particular, certain substituted polysaccharides, such as cellulosic materials, can be difficult to grind due to the fibrous nature of the material. As such, some mills, such as impact mills, are less effective on certain substituted polysaccharides and mills with a cutting action are needed to cut the substituted polysaccharide to a smaller size. In a small-scale environment such as a lab, substituted polysaccharides, such as blocky carboxymethyl cellulose, can be ground using a Retsch ZM-200 mill. Due to the difficulty in micronizing substituted polysaccharides, such as blocky carboxymethyl cellulose, the substituted polysaccharide can be ground in two stages and at a very low rate. In the first step of such a process, unground substituted polysaccharides is fed at low rate (<50 g/min) into a ZM-200 grinder operating at 12000 rpm and with a 1 mm hole sieve installed. After this initial grinding, the partially ground substituted polysaccharides was fed back through the ZM-200, now fitted with a 0.5 mm hole sieve and running at 12000 rpm. This gave a material with a mean particle size of less than 100 microns.

### Preferred Substituted Polysaccharides

The substituted polysaccharide may in particular be chosen from carboxymethyl cellulose, methylcarboxymethylcellulose, sulfoethylcellulose, methylhydroxyethylcellulose, carboxymethyl xyloglucan, carboxymethyl xylan, sulfoethylgalactomannan, carboxymethyl galactomannan, hydoxyethyl galactomannan, sulfoethyl starche, carboxymethyl starch, and mixture thereof. In one particularly preferred alternative, the substituted polysaccharide is carboxymethyl cellulose.

### Laundry Adjunct Ingredient

The laundry treatment composition further comprises a laundry adjunct ingredient. This laundry adjunct ingredient is different to the ingredient(s) required to obtain the substituted polysaccharide. For example, the laundry adjunct ingredient is not the solvent used to obtain the substituted polysaccharide by reacting the polysaccharide backbone and the substituent. The precise nature of these additional adjunct components, and levels of incorporation thereof, will depend on the physical form of the composition and the nature of the operation for which it is to be used. Suitable adjunct materials include, but are not limited to, surfactants, builders, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, and/or pigments. In addition to the disclosure below, suitable examples of such other adjuncts and levels of use are found in U.S. Pat. Nos. 5,576,282, 6,306,812 B1 and 6,326,348 B1 that are incorporated by reference. Such one or more adjuncts may be present as detailed below:

ENZYME—Preferably, the composition of the invention further comprises an enzyme. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. The compositions of the present invention may in particular comprise an enzyme having endo-β-1,4-glucanase activity (E.C.3.4.1.4). Non-limiting examples of suitable endo-β-1,4-glucanase enzymes include Celluclean (Novozymes), Carezyme (Novozymes), Celluzyme (Novozymes), Endolase (Novozymes), KAC (Kao), Puradax HA (Genencor), Puradax EG-L (Genencor), the 20 kDa endo-β-1,4-glucanase endogenous to Melanocarpus Albomyces sold under the Biotouch brand (AB Enzymes), and variants and mixtures of these. Suitable enzymes are listed in WO2007/025549A1, page 4 line 15 to page 11 line 2.

When present in the detergent composition, the aforementioned enzymes may be present at levels from about 0.00001% to about 2%, from about 0.0001% to about 1% or even from about 0.001% to about 0.5% or 0.02% enzyme protein by weight of the composition.

SURFACTANT—The compositions according to the present invention may comprise a surfactant or surfactant system. The compositions may comprise from 0.01% to 90%, for example from 1 to 25, or from 2 to 20, or from 4 to 15, or from 5 to 10%, by weight of a surfactant system. The surfactant may be selected from nonionic surfactants, anionic surfactants, cationic surfactants, ampholytic surfactants, zwitterionic surfactants, semi-polar nonionic surfactants and mixtures thereof.

### Anionic Surfactants

Typically, the composition comprises from 1 to 50 wt % or from 2 to 40 wt % anionic surfactant.

Suitable anionic surfactants typically comprise one or more moieties selected from the group consisting of carbonate, phosphate, phosphonate, sulfate, sulfonate, carboxylate and mixtures thereof. The anionic surfactant may be one or mixtures of more than one of C₈₋₁₈ alkyl sulfates and C₈₋₁₈ alkyl sulfonates, linear or branched, optionally condensed with from 1 to 9 moles of C₁₋₄ alkylene oxide per mole of C₈₋₁₈ alkyl sulfate and/or C₈₋₁₈ alkyl sulfonate.

Preferred anionic detersive surfactants are selected from the group consisting of: linear or branched, substituted or unsubstituted, C₁₂₋₁₈ alkyl sulfates; linear or branched, substituted or unsubstituted, C₁₀₋₁₃ alkylbenzene sulfonates, preferably linear C₁₀₋₁₃ alkylbenzene sulfonates; and mixtures thereof. Highly preferred are linear C₁₀₋₁₃ alkylbenzene sulfonates. Highly preferred are linear C₁₀₋₁₃ alkylbenzene sulfonates that are obtainable, preferably obtained, by sulfonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

### Alkoxylated Anionic Surfactants

The composition may comprise an alkoxylated anionic surfactant. When present alkoxylated anionic surfactant will generally be present in amounts form 0.1 wt % to 40 wt %, for example from 1 wt % to 3 wt % based on the detergent composition as a whole.

Typically, the alkoxylated anionic detersive surfactant is a linear or branched, substituted or unsubstituted C₁₂₋₁₈ alkyl alkoxylated sulfate having an average degree of alkoxylation of from 1 to 30, preferably from 3 to 7.

Suitable alkoxylated anionic detersive surfactants are: Texapan LEST™ by Cognis; Cosmacol AES™ by Sasol; BES151™ by Stephan; Empicol ESC70/U™; and mixtures thereof.

### Non-Ionic Detersive Surfactant

The compositions of the invention may comprise non-ionic surfactant. Where present the non-ionic detersive surfactant(s) is generally present in amounts of from 0.5 to 20 wt %, or from 2 wt % to 4 wt %.

The non-ionic detersive surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₋₄-C₂₂ mid-chain branched alcohols, BA, as described in more detail in U.S. Pat. No. 6,150,322; C₁₋₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

### Cationic Detersive Surfactant

In one aspect of the invention, the detergent compositions are free of cationic surfactant. However, the composition optionally may comprise a cationic detersive surfactant. When present, preferably the composition comprises from 0.1 wt % to 10 wt %, or from 1 wt % to 2 wt % cationic detersive surfactant.

Suitable cationic detersive surfactants are alkyl pyridinium compounds, alkyl quaternary ammonium compounds, alkyl quaternary phosphonium compounds, and alkyl ternary sulfonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

BUILDER—The detergent composition may comprise one or more builders. When a builder is used, the subject composition will typically comprise from 1% to about 40%, typically from 2 to 25%, or even from about 5% to about 20%, or from 8 to 15% by weight of builder.

The detergent compositions of the present invention comprise from 0 to 20%, in particular less than 15% or 10%, for example less than 5% of zeolite. In particular, the detergent composition comprises from 0 to 20%, in particular less than 15% or 10%, for example less than 5% of aluminosilicate builder(s).

The detergent composition of the present invention may comprise from 0 to 20%, in particular less than 15% or 10%, for example less than 5% of phosphate builder and/or silicate builder and/or zeolite builder.

The detergent compositions of the present invention may comprise from 0 to 20%, in particular less than 15% or 10%, for example less than 5% of sodium carbonate.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

The total amount of phosphate builder(s), aluminosilicate builder(s), polycarboxylic acid builder(s), and additional silicate builder(s) in the detergent composition may be comprised from 0 to 25%, or even from 1 to 20%, in particular from 1 to 15%, especially from 2 to 10%, for example from 3 to 5%, by weight.

The composition may further comprise any other supplemental builder(s), chelant(s), or, in general, any material which will remove calcium ions from solution by, for example, sequestration, complexation, precipitation or ion exchange. In particular the composition may comprise materials having at a temperature of 25° C. and at a 0.1M ionic strength a calcium binding capacity of at least 50 mg/g and a calcium binding constant log K Ca²⁺ of at least 3.50.

In the composition of the invention, the total amount of phosphate builder(s), aluminosilicate builder(s), polycarboxylic acid builder(s), additional silicate builder(s), and other material(s) having a calcium binding capacity superior to 50 mg/g and a calcium binding constant higher than 3.50 in the composition may be comprised from 0 to 25%, or even from 1 to 20%, in particular from 1 to 15%, especially from 2 to 10%, for example from 3 to 5%, by weight.

FLOCCULATING AID—The composition may further comprise a flocculating aid. The composition may also be substantially free of flocculating aid. Typically, the flocculating aid is polymeric. Typically the flocculating aid is a polymer comprising monomer units selected from the group consisting of ethylene oxide, acrylamide, acrylic acid and mixtures thereof. Typically the flocculating aid is a polyethyleneoxide. Typically the flocculating aid has a molecular weight of at least 100,000 Da, in particular from 150,000 Da to 5,000,000 Da or even from 200,000 Da to 700,000 Da. Typically, the composition comprises at least 0.3% by weight of the composition of a flocculating aid.

BLEACHING AGENT—The compositions of the present invention may comprise one or more bleaching agents. In general, when a bleaching agent is used, the compositions of the present invention may comprise from about 0.1% to about 50% or even from about 0.1% to about 25% bleaching agent by weight of the subject detergent composition. When present, suitable bleaching agents include bleaching catalysts, suitable bleaching catalysts are listed in WO2008/034674A1, page 46 line 23 to page 49 line 17, photobleaches for example Vitamin K3 and zinc or aluminium phtalocyanine sulfonate; bleach activators such as tetraacetyl ethylene diamine (TAED) and nonanoyloxybenzene sulfonate (NOBS); hydrogen peroxide; pre-formed peracids; sources of hydrogen peroxide such as inorganic perhydrate salts, including alkali metal salts such as sodium salts of perborate (usually mono- or tetra-hydrate), percarbonate, persulfate, perphosphate, persilicate salts and mixtures thereof, optionally coated, suitable coatings including inorganic salts such as alkali metal; and mixtures thereof.

The amounts of hydrogen peroxide source and peracid or bleach activator may be selected such that the molar ratio of available oxygen (from the peroxide source) to peracid is from 1:1 to 35:1, or even 2:1 to 10:1

FLUORESCENT WHITENING AGENT—The composition may contain components that may tint articles being cleaned, such as fluorescent whitening agent. When present, any fluorescent whitening agent suitable for use in a detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives.

Typical fluorescent whitening agents are Parawhite KX, supplied by Paramount Minerals and Chemicals, Mumbai, India; Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino) stilbene disulfonate. Tinopal® CBS is the disodium salt of 2,2′-bis-(phenyl-styryl) disulfonate.

FABRIC HUEING AGENTS—Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Suitable hueing dyes are listed in WO2008/17570A1, page 4 line 15 to page 11 line 18 and WO2008/07318A2, page 9, line 18 to page 21 line 2.

POLYMERIC DISPERSING AGENTS—the compositions of the present invention can contain additional polymeric dispersing agents. Suitable polymeric dispersing agents, include polymeric polycarboxylates, substituted (including quarternized and oxidized) polyamine polymers, and polyethylene glycols, such as: acrylic acid-based polymers having an average molecular of about 2,000 to about 10,000; acrylic/maleic-based copolymers having an average molecular weight of about 2,000 to about 100,000 and a ratio of acrylate to maleate segments of from about 30:1 to about 1:1; maleic/acrylic/vinyl alcohol terpolymers; polyethylene glycol (PEG) having a molecular weight of about 500 to about 100,000, preferably from about 1,000 to about 50,000, more preferably from about 1,500 to about 10,000; and water soluble or dispersible alkoxylated polyalkyleneamine materials. These polymeric dispersing agents, if included, are typically at levels up to about 5%, preferably from about 0.2% to about 2.5%, more preferably from about 0.5% to about 1.5%.

POLYMERIC SOIL RELEASE AGENT—The compositions of the present invention can also contain polymeric soil release agent. polymeric soil release agent, or “SRA”, have hydrophilic segments to hydrophilize the surface of hydrophobic fibers such as polyester and nylon, and hydrophobic segments to deposit upon hydrophobic fibers and remain adhered thereto through completion of washing and rinsing cycles, thereby serving as an anchor for the hydrophilic segments. This can enable stains occurring subsequent to treatment with the SRA to be more easily cleaned in later washing procedures. Preferred SRA's include oligomeric terephthalate esters; sulfonated product of a substantially linear ester oligomer comprised of an oligomeric ester backbone of terephthaloyl and oxyalkyleneoxy repeat units and allyl-derived sulfonated terminal moieties covalently attached to the backbone; nonionic end-capped 1,2-propylene/polyoxyethylene terephthalate polyesters; an oligomer having empirical formula (CAP)₂ (EG/PG)₅ (T)₅ (SIP)₁ which comprises terephthaloyl (T), sulfoisophthaloyl (SIP), oxyethyleneoxy and oxy-1,2-propylene (EG/PG) units and which is preferably terminated with end-caps (CAP), preferably modified isethionates, as in an oligomer comprising one sulfoisophthaloyl unit, 5 terephthaloyl units, oxyethyleneoxy and oxy-1,2-propyleneoxy units in a defined ratio, preferably about 0.5:1 to about 10:1, and two-end-cap units derived from sodium 2-(2-hydroxyethoxy)-ethanesulfonate; oligomeric esters comprising: (1) a backbone comprising (a) at least one unit selected from the group consisting of dihydroxy sulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, preferably ethoxylated, isethionates, alkoxylated propanesulfonates, alkoxylated propanedisulfonates, alkoxylated phenolsulfonates, sulfoaroyl derivatives and mixtures thereof. Preferred are esters of the empirical formula:

((CAP)ₐ(EG/PG)_{b}(DEG)_{c}PEG)_{d}(T)ₑ(SIP)_{f}(SEG)_{g}(B)ₕ)

wherein CAP, EG/PG, PEG, T and SIP are as defined hereinabove, DEG represents di(oxyethylene)oxy units, SEG represents units derived from the sulfoethyl ether of glycerin and related moiety units, B represents branching units which are at least trifunctional whereby ester linkages are formed resulting in a branched oligomer backbone, a is from about 1 to about 12, b is from about 0.5 to about 25, c is from 0 to about 12, d is from 0 to about 10, b+c+d totals from about 0.5 to about 25, e is from about 1.5 to about 25, f is from 0 to about 12; e+f totals from about 1.5 to about 25, g is from about 0.05 to about 12; h is from about 0.01 to about 10, and a, b, c, d, e, f, g, and h represent the average number of moles of the corresponding units per mole of the ester; and the ester has a molecular weight ranging from about 500 to about 5,000; and; cellulosic derivatives such as the hydroxyether cellulosic polymers available as METHOCEL® from Dow; the C₁-C₄ alkyl polysaccharides and C₄ hydroxyalkyl polysaccharides, see U.S. Pat. No. 4,000,093, issued Dec. 28, 1976 to Nicol et al., and the methyl polysaccharide ethers having an average degree of substitution (methyl) per anhydrosugar unit from about 1.6 to about 2.3 and a solution viscosity of from about 80 to about 120 centipoise measured at 20° C. as a 2% aqueous solution. Such materials are available as METOLOSE SM100® and METOLOSE SM200®, which are the trade names of methyl polysaccharide ethers manufactured by Shinetsu Kagaku Kogyo KK.

ENZYME STABILIZERS—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

CATALYTIC METAL COMPLEXES—The compositions of the invention may comprise catalytic metal complexes. When present, one type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo [6.6.2]hexadecane.

Suitable transition metal MRLs are readily prepared by known procedures, such as taught for example in WO 00/32601, and U.S. Pat. No. 6,225,464.

SOFTENING SYSTEM—the compositions of the invention may comprise a softening agent and optionally also with flocculants and enzymes; optionally for softening through the wash.

FABRIC SOFTENING BOOSTING COMPONENT—Typically, the composition additionally comprises a charged polymeric fabric-softening boosting component. When the composition comprises clay and silicone particles, preferably, the charged polymeric fabric-softening boosting component is contacted to the clay and silicone in step (ii) of the process for obtaining clay and silicone particles (see above). The intimate mixing of the charged polymeric fabric-softening boosting component with the clay and silicone further improves the fabric-softening performance of the resultant composition.

COLORANT—the compositions of the invention may comprise a colorant, preferably a dye or a pigment. Particularly, preferred dyes are those which are destroyed by oxidation during a laundry wash cycle. To ensure that the dye does not decompose during storage it is preferable for the dye to be stable at temperatures up to 40° C. The stability of the dye in the composition can be increased by ensuring that the water content of the composition is as low as possible. If possible, the dyes or pigments should not bind to or react with textile fibres. If the colorant does react with textile fibres, the colour imparted to the textiles should be destroyed by reaction with the oxidants present in laundry wash liquor. This is to avoid coloration of the textiles, especially over several washes. Particularly, preferred dyes include but are not limited to Basacid® Green 970 from BASF and Monastral blue from Albion.

### Laundry Treatment Composition

The laundry treatment composition is preferably a liquid laundry detergent composition or a fabric care composition.

The laundry treatment composition may comprise a from about 1 wt % to about 99 wt % solvent. Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

The laundry treatment composition may also be in the form of a liquid, gel, paste, dispersion, preferably a colloidal dispersion or any combination thereof. Liquid compositions typically have a viscosity of from 500 mPa·s to 3,000 mPa·s, when measured at a shear rate of 20 s⁻¹ at ambient conditions (20° C. and 1 atmosphere), and typically have a density of from 800 g/l to 1300 g/1. If the composition is in the form of a dispersion, then it will typically have a volume average particle size of from 1 micrometer to 5,000 micrometers, preferably from 1 micrometer to 50 micrometers. The particles that form the dispersion are usually the clay and, if present, the silicone. Typically, a Coulter Multisizer is used to measure the volume average particle size of a dispersion.

The laundry treatment composition may be in unit dose form, including not only tablets, but also unit dose pouches wherein the composition is at least partially enclosed, preferably completely enclosed, by a film such as a polyvinyl alcohol film. The laundry treatment composition or any component thereof may also be included in the film, such as a polyvinyl alcohol film, of the unit dose form.

The laundry treatment composition may be capable of cleaning and/or softening fabric during a laundering process. Typically, the laundry treatment composition is formulated for use in an automatic washing machine, although it can also be formulated for hand-washing use.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition being a liquid laundry treatment composition or component thereof, comprising:
a. a substituted polysaccharide particle having a mean particle size as expressed by the area-equivalent diameter from about 1 to 100 μm according to ISO 9276-6; and
b. a laundry adjunct ingredient.

2. A composition according to claim 1, wherein the substituted polysaccharide particle is a substituted cellulose.

3. A composition according to claim 1, wherein the substituted polysaccharide particle is an anionically modified cellulose.

4. A composition according to claim 1, wherein the substituted polysaccharide particle is carboxymethyl cellulose.

5. A composition according to claim 1, wherein the substituted polysaccharide particle has a degree of substitution, DS, of from 0.01 to 0.99.

6. A composition according to claim 2, wherein the substituted polysaccharide particle has a degree of substitution, DS, of at least 0.55.

7. A composition according to claim 1, wherein the substituted polysaccharide particle has a degree of blockiness, DB, such that a DS+DB is of at least 1.00.

8. A composition according to claim 4, wherein the substituted polysaccharide particle has a degree of blockiness, DB, of at least 0.35.

9. A composition according to claim 4, wherein the substituted polysaccharide particle has a DS+DB, of from 1.05 to 2.00.

10. A composition according to claim 1, wherein the mean particle size as expressed by the area-equivalent diameter is from about 40 to 50 μm according to ISO 9276-6

11. A composition according to claim 1, further comprising an adjunct ingredient, wherein the adjunct ingredient is selected from the group comprising bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylates, structurant and mixtures thereof.

12. A method of cleaning a fabric with a composition according to claim 1, said method comprising the steps of applying the contacting the fabric with the composition.

13. A laundry treatment composition comprising the composition according to claim 1, wherein the composition is a unit dose pouch, wherein the composition is at least partially enclosed by a polyvinyl alcohol film.
